(19) United States
(12) Patent Application Publication
(10) Pub. No.: US 2026/0121175 A1
(43) Pub. Date: Apr. 30, 2026

(54) SECONDARY BATTERY AND METHOD OF MANUFACTURING THE SECONDARY BATTERY

(71) Applicant: SAMSUNG SDI CO., LTD., Yongin-si (KR)

(72) Inventor: Eungkuk HEO, Yongin-si (KR)

(21) Appl. No.: 19/325,849

(22) Filed: Sep. 11, 2025

(30) Foreign Application Priority Data
Oct. 30, 2024 (KR) 10-2024-0150947

(51) Int. Cl. H01M 50/103; H01M 10/04; H01M 50/119; H01M 50/133; H01M 50/15; H01M 50/159; H01M 50/169; H01M 50/55

(52) U.S. Cl. CPC H01M 50/103; H01M 10/0486; H01M 10/049; H01M 50/119; H01M 50/133; H01M 50/15; H01M 50/159; H01M 50/169; H01M 50/55

(57) ABSTRACT

A secondary battery may include an electrode assembly including a first electrode plate having a first polarity, a separator, and a second electrode plate having a second polarity different from the first polarity and a case accommodating the electrode assembly, and the case may include a body frame with two open surfaces facing each other, a first case plate coupled to an edge of an open first surface of the body frame, and a second case plate coupled to an edge of an open second surface of the body frame facing the open first surface.

### CROSS-REFERENCE TO RELATED APPLICATION

The present application claims priority to and the benefit of Korean Application No. 10-2024-0150947, filed on Oct. 30, 2024, in the Korean Intellectual Property Office, the entire disclosure of which is incorporated by reference herein.

### BACKGROUND

### Technical Field

Aspects of embodiments of the present disclosure relate to a secondary battery and a method for manufacturing the same.

### Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

Conventional secondary batteries in a square shape are manufactured by accommodating an electrode assembly in a case body with one open surface, then coupling a case cover or a cap plate to the open surface. Such a case body is formed to have a defined shape by bending the metal. However, conventional secondary batteries in a square shape have a case which is fixed to one shape, so they cannot accommodate an electrode assembly having a shape different from the shape of the case.

The above information disclosed in this Background section is for enhancement of understanding of the background of the present disclosure, and therefore, it may contain information that does not constitute related (or prior) art.

### SUMMARY

Embodiments of the present disclosure provide a secondary battery and a method for manufacturing the same.

These and other aspects and features of the present disclosure will be described in or will be apparent from the following description of embodiments of the present disclosure.

A secondary battery according to one embodiment of the present disclosure includes an electrode assembly including a first electrode plate having a first polarity, a separator, and a second electrode plate having a second polarity different from the first polarity and a case accommodating the electrode assembly. The case includes a body frame with a first open surface facing a second open surface, a first case plate coupled to an edge of the open first surface of the body frame, and a second case plate coupled to an edge of the open second surface of the body frame facing the open first surface.

According to one embodiment of the present disclosure, a planar shape of the first case plate may correspond to a planar shape of the electrode assembly.

According to one embodiment of the present disclosure, a planar shape of the body frame may correspond to a planar shape of the electrode assembly.

According to one embodiment of the present disclosure, the edge of the open first surface and an outermost area of the first case plate may be welded together, and the edge of the open second surface and an outermost area of the second case plate may be welded together.

According to one embodiment of the present disclosure, a thickness of the body frame may be greater than a thickness of at least one of the first case plate and the second case plate.

According to one embodiment of the present disclosure, a thickness of the first case plate may be different from a thickness of the second case plate.

According to one embodiment of the present disclosure, at least one of the first case plate, the second case plate, and the body frame may contain an alloy material.

According to one embodiment of the present disclosure, a material of the first case plate may be different from a material of the body frame.

According to one embodiment of the present disclosure, a material of the first case plate may be different from a material of the second case plate.

According to one embodiment of the present disclosure, the secondary battery may further include an electrode terminal, wherein the electrode terminal is electrically connected to the first electrode plate or the second electrode plate, and wherein the electrode terminal is arranged on a third surface of the body frame, and the third surface may be different from the open first surface and the open second surface.

A case of a secondary battery according to one embodiment of the present disclosure includes a body frame having a planar shape corresponding to a planar shape of an electrode assembly and having a first open surface facing a second open surface, a first case plate coupled to an edge of the open first surface of the body frame, and a second case plate coupled to an edge of the open second surface of the body frame facing the open first surface.

According to one embodiment of the present disclosure, the edge of the open first surface and an outermost area of the first case plate may be welded together, and the edge of the open second surface and an outermost area of the second case plate may be welded together.

According to one embodiment of the present disclosure, a thickness of the body frame may be greater than a thickness of at least one of the first case plate and the second case plate.

According to one embodiment of the present disclosure, at least one of the first case plate, the second case plate, and the body frame may contain an alloy material.

A method of manufacturing a secondary battery according to one embodiment of the present disclosure includes preparing a body frame having a planar shape corresponding to a planar shape of an electrode assembly, the body frame having a first open surface and a second open surface, coupling a first plate to an edge of the open first surface of the body frame, accommodating the electrode assembly in the first plate and the body frame, which have been coupled with each other, and coupling a second plate to an edge of the open second surface of the body frame facing the open first surface.

According to one embodiment of the present disclosure, the coupling of the first plate may include welding the edge of the open first surface and an outermost area of the first plate together.

According to one embodiment of the present disclosure, the coupling of the second plate may include welding the edge of the open second surface and an outermost area of the second plate together.

According to one embodiment of the present disclosure, the method may further include arranging an electrode terminal on a third surface of the body frame and electrically connecting the electrode terminal to a first electrode plate or a second electrode plate. The electrode assembly may include the first electrode plate having a first polarity, a separator, and the second electrode plate having a second polarity different from the first polarity, and the third surface may be different from the open first surface and the open second surface.

According to one embodiment of the present disclosure, a planar shape of the first plate or the second plate may correspond to the planar shape of the electrode assembly.

According to one embodiment of the present disclosure, a thickness of the body frame may be greater than a thickness of at least one of the first plate and the second plate.

According to some embodiments of the present disclosure, the thickness of a body frame of a case of a secondary battery may be increased, so that the safety of the case may be improved and the thickness of a plate for sealing an open surface of the body frame may be reduced, increasing the internal capacity of the case of the secondary battery.

According to some embodiments of the present disclosure, by using a case of a secondary battery formed by assembling a body frame and plates having a shape corresponding to the shape of an electrode assembly, it may be possible to manufacture amorphous secondary batteries having various shapes and materials. In addition, because a body frame and plates are welded together, it may be possible to skip a pressing process (i.e., a process in which the material is pressed or bent into the desired shape) to form a space for accommodating an electrode assembly inside a case, thereby reducing the cost of manufacturing a secondary battery.

These and other aspects and features of the present disclosure will be described in or will be apparent from the following description of embodiments of the present disclosure.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is an exploded perspective view of an example of a secondary battery according to one embodiment of the present disclosure;

FIG. 2 is an exploded perspective view of an example of the thickness of a case according to one embodiment of the present disclosure;

FIG. 3 shows an example of a case of a secondary battery according to one embodiment of the present disclosure;

FIG. 4 shows an example of a case of a secondary battery according to one embodiment of the present disclosure;

FIG. 5 is a flow chart of an example of a method of manufacturing a secondary battery according to one embodiment of the present disclosure;

FIG. 6 shows an example of how a body frame is coupled with a first plate according to one embodiment of the present disclosure;

FIG. 7 shows an example of how an electrode assembly is accommodated in a case according to one embodiment of the present disclosure;

FIG. 8 shows an example of how a body frame is coupled with a second plate according to one embodiment of the present disclosure; and

FIG. 9 shows an example of a welding area according to one embodiment of the present disclosure.

### DETAILED DESCRIPTION

Hereinafter, embodiments of the present disclosure will be described, specifically with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when a layer or element is referred to as being “between” two layers, it can be the only layer between the two layers, or one or more intervening layers may also be present. It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of local patent laws.

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be provided in contact with the upper (or lower) surface of the element, and another element may also be interposed between the element and the arbitrary element provided on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

In the present disclosure, the size and relative size of layers and areas depicted in the drawings may have been exaggerated for clarity of description. That is, the sizes shown in the drawings are only for convenience of understanding and are not limited thereto. In addition, the same reference numerals refer to the same components throughout this specification.

In the present disclosure, a “planar shape” may refer to a two-dimensional shape of a three-dimensional shape seen when looking down on the three-dimensional shape. In addition, in the present disclosure, the upper part of a drawing may be referred to as the “upper part” or “upper side” of a component depicted in the drawing, and the lower part thereof may be referred to as the “lower part” or “lower side” of the component. Such relative expressions, such as “upper part” and “upper side,” may be used to describe the relationship between components depicted in the drawings, and the present disclosure is not limited by the expressions.

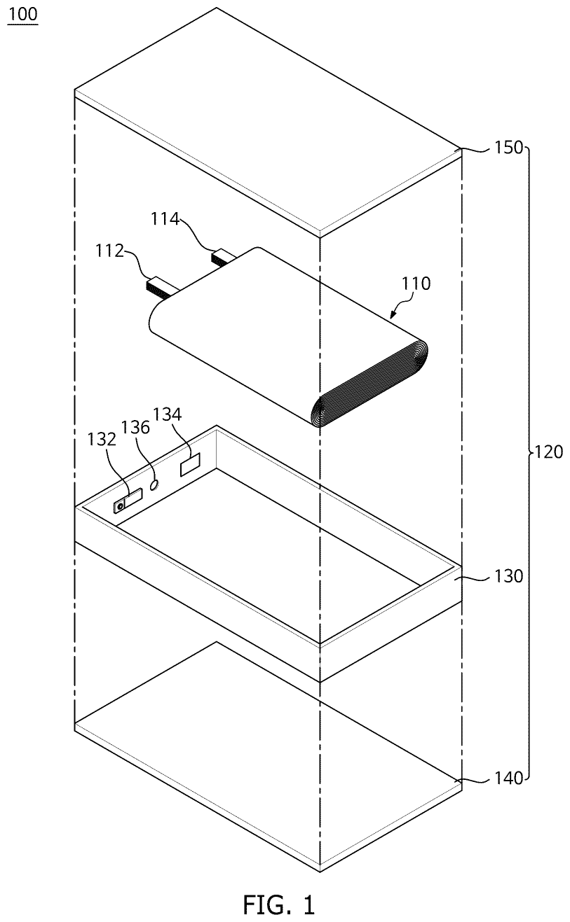

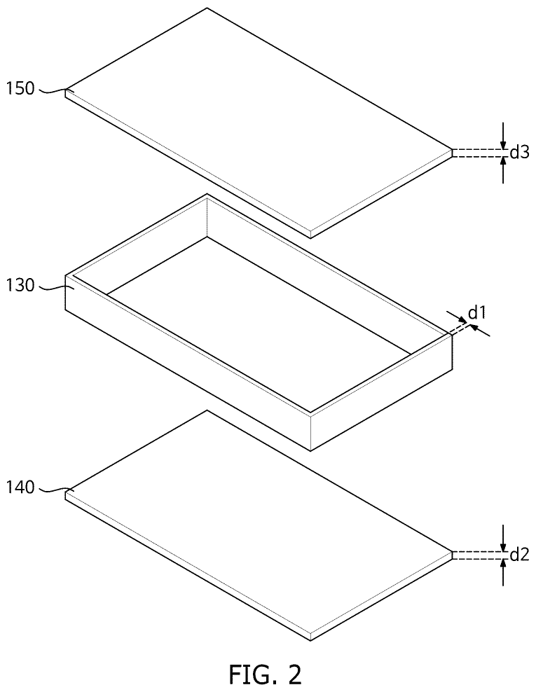

FIG. 1 is an exploded perspective view of an example of a secondary battery 100 according to one embodiment of the present disclosure, and FIG. 2 is an exploded perspective view of an example of the thicknesses of a case 120 according to one embodiment of the present disclosure. In one embodiment, the secondary battery 100 may include an electrode assembly 110 including a first electrode plate (e.g., a positive electrode plate) having a first polarity, a separator, and a second electrode plate (e.g., a negative electrode plate) having a second polarity different from the first polarity, and a case 120 that accommodates the electrode assembly 110. Here, the case 120 may include a body frame 130 with two open sides facing each other, a first plate 140 coupled to the edge of an open first surface (e.g., a lower surface) of the body frame 130, and a second plate 150 coupled to the edge of an open second surface (e.g., an upper surface) of the body frame 130 facing the first surface. In an example, the electrode assembly 110 may be wound or laminated with a separator, also known as an insulator, interposed between the first and second electrode plates.

In one embodiment, the case 120 illustrated in FIG. 1 may contain an alloy material. Specifically, at least one of the body frame 130, the first plate 140, and the second plate 150 may contain an alloy material. In non-limiting example, the case 120 may contain stainless steel (i.e., Steel Use Stainless (SUS)), so the secondary battery 100 may be a SUS-can-type secondary battery. In an example, the case 120 may be formed of a conductive metal such as aluminum, an aluminum alloy, or nickel-plated steel to form the overall appearance of the secondary battery 100.

In one embodiment, the material of the first plate 140 may be different from the material of the body frame 130. In a non-limiting example, the material of the first plate 140 may be aluminum while the material of the body frame 130 may be stainless steel. In addition, the material of the first plate 140 may be different from the material of the second plate 150. Similarly, the material of the second plate 150 may be different from the material of the body frame 130. Furthermore, the materials of the first plate 140, the body frame 130, and the second plate 150 may be different from one other.

The secondary battery 100 in FIG. 1 may be a lithium secondary battery, but the present disclosure is not limited thereto.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (AI) but is not limited thereto.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiaA1-bXbO2-cDc (0.90≤a≤1.8, 0≤b≤0.5, 0≤c≤0.05); LiaMn2-bXbO4-cDc (0.90≤a≤1.8, 0≤b≤0.5, 0≤c≤0.05); LiaNi1-b-cCobXcO2-αDα (0.90≤a≤1.8, 0≤b≤0.5, 0≤c≤0.5, 0<α<2); LiaNi1-b-cMnbXcO2-αDα (0.90≤a≤1.8, 0≤b≤0.5, 0≤c≤0.5, 0<α<2); LiaNibCocL1dGeO2 (0.90≤a≤1.8, 0≤b≤0.9, 0≤c≤0.5, 0≤d≤0.5, 0≤e≤0.1); LiaNiGbO2 (0.90≤a≤1.8, 0.001≤b≤0.1); LiaCoGbO2 (0.90≤a≤1.8, 0.001≤b≤0.1); LiaMn1-bGbO2 (0.90≤a≤1.8, 0.001≤b≤0.1); LiaMn2GbO4 (0.90≤a≤1.8, 0.001≤b≤0.1); LiaMn1-gGgPO4 (0.90≤a≤1.8, 0≤g≤0.5); Li(3-f)Fe2(PO4)3 (0≤f≤2); and LiaFePO4 (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

A negative electrode for a lithium secondary battery may include a current collector and a negative electrode active material layer provided on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOx (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

The separator interposed between the first electrode plate (e.g., the negative electrode) and the second electrode plate (e.g., the positive electrode) may be made from materials such as polyethylene, polypropylene, and/or polyvinylidene fluoride, and may be formed into a multilayer film of two or more layers.

The separator may further include a porous substrate and a coating layer including an organic material, an inorganic material, or a combination thereof on one or both surfaces of the porous substrate.

The organic material may include a polyvinylidene fluoride-based heavy antibody or a (meth)acrylic polymer.

The inorganic material may include inorganic particles selected from Al2O3, SiO2, TiO2, SnO2, CeO2, MgO, NiO, CaO, GaO, ZnO, ZrO2, Y2O3, SrTiO3, BaTiO3, Mg(OH)2, boehmite, and combinations thereof but is not limited thereto.

The organic material and the inorganic material may be mixed in one coating layer or may be in the form of a coating layer containing an organic material and a coating layer containing an inorganic material that are laminated on each other.

In one embodiment, the electrode assembly 110 may have a first tab 112 connected to one side of the first electrode plate and a second tab 114 connected to one side of the second electrode plate. The first tab 112 and the second tab 114 may be connected thereto by welding each tab to the uncoated portion of each of the first and second electrode plates, and may be formed by punching out the uncoated portions of the first and second electrode plates. When the electrode assembly 110 has been wound, it may have the first tab 112 and the second tab 114 arranged in parallel with a predetermined gap therebetween. However, the first tab 112 and the second tab 114 may also be placed on different sides of the secondary battery 100. That is, the electrode assembly 110 may have any shape or structure so long as it contains electrode tabs connected thereto.

In one embodiment, the body frame 130 may include a first electrode terminal 132 and a second electrode terminal 134. Here, the first electrode terminal 132 may be electrically connected to the first tab 112 of the electrode assembly 110, and the second electrode terminal 134 may be electrically connected to the second tab 114 of the electrode assembly 110. In other embodiments, the first electrode terminal 132 may be directly and electrically connected to the first electrode plate (i.e., without the first tab 112), and the second electrode terminal 134 may be directly and electrically connected to the second electrode plate (i.e., without the second tab 114).

In one embodiment, the first electrode terminal 132 and/or the second electrode terminal 134 may be formed on a third surface, e.g., a side surface, of the body frame 130. Here, the third surface may be a surface other than the first and second surfaces. The positions of the first electrode terminal 132 and the second electrode terminal 134 according to the present disclosure are not limited to the positions shown in FIG. 1, and various modified examples may be possible.

In one embodiment, the body frame 130 may include an electrolyte inlet 136. In an example, the electrolyte inlet 136 may be a through hole formed on one surface, e.g., the third surface, of the body frame 130, and may be formed to inject an electrolyte into the case of the secondary battery 100 after the body frame 130, the first plate 140, and the second plate 150 have been joined and sealed. After the electrolyte has been injected, a sealing plug may be attached to the electrolyte inlet 136. As illustrated, the electrolyte inlet 136 according to the present disclosure may be placed between the first electrode terminal 132 and the second electrode terminal 134. However, the present disclosure is not limited thereto, and various modified examples may be possible.

In one embodiment, the body frame 130 may be formed by performing pressing, punching, etc., on a flat plate made of a metal material. An accommodating portion for accommodating the electrode assembly 110 may be formed in the central area of the body frame 130 manufactured in such a manner. In addition, a side wall may be formed at the edge of the accommodating portion. Thus, the body frame 130 may be formed to have a shape corresponding to the shape of the electrode assembly 110, e.g., a flat shape.

In one embodiment, the body frame 130, the first plate 140, and the second plate 150 may be joined to form the outer appearance of the secondary battery 100. In an example, the body frame 130, the first plate 140, and the second plate 150 may be metal-joined by welding, brazing, soldering, etc. In this case, the edge of the first surface of the body frame 130 and the outermost area of the first plate 140 may be welded together, and the edge of the second surface of the body frame 130 and the outermost area of the second plate 150 may be welded together.

In one embodiment, the planar shape of at least one of the first plate 140 and the second plate 150 may correspond to the planar shape of the electrode assembly 110. In an example, when the planar shape of the electrode assembly 110 is rectangular, the planar shape of at least one of the first plate 140 and the second plate 150 may be rectangular. For another example, when the planar shape of the electrode assembly 110 is pentagonal, the planar shape of at least one of the first plate 140 and the second plate 150 may be pentagonal. In addition, the planar shape of the body frame 130 may also correspond to the planar shape of the electrode assembly 110.

The secondary battery 100 may be a lithium battery cell, a sodium battery cell, etc. However, the scope of the present disclosure is not limited thereto, and examples of the secondary battery 100 may include all batteries that can repeatedly store and provide electricity by charging and discharging. In one embodiment, when the secondary battery 100 is a lithium battery cell, it may be used for an electric vehicle (EV) because a lithium battery cell has excellent life properties and high-rate properties. Likewise, the secondary battery 100 may be used for a hybrid vehicle such as a plug-in hybrid electric vehicle (PHEV). In addition, lithium battery cells can be used in a range of fields that require power storage, such as smartphones, tablet PCs, electric bicycles, and/or power tools.

Referring to FIG. 2, a thickness d1 of the body frame 130 may be greater than at least one of a thickness d2 of the first plate 140 and a thickness d3 of the second plate 150. In addition, the thickness d2 of the first plate 140 may be different from the thickness d3 of the second plate 150. In addition, the thickness d1 of the body frame 130, the thickness d2 of the first plate 140, and the thickness d3 of the second plate 150 may be different from each other. Accordingly, it may be possible to secure a sufficient welding area for coupling the edge of the open surface of the body frame 130 with the first plate 140 or the second plate 150 by increasing the thickness d1 of the body frame 130. In addition, it may be possible to increase the internal capacity of the case 120 of the secondary battery 100 by reducing the thickness d2 of the first plate 140 or the thickness d3 of the second plate 150 while improving the durability or safety of the case 120 by increasing the thickness d1 of the body frame 130.

In an example, compared to a conventional can-shaped case having a thickness of 0.1 mm, when the thickness d1 of the body frame 130 is 0.1 mm and the thicknesses d2 and d3 of each of the first plate 140 and the second plate 150 is 0.075 mm, the increase in the internal capacity of the case 120 relative to the total height of the case 120 may be as shown in Table 1 below.

TABLE 1

| | | | | | | | | | | | |
|---|---|---|---|---|---|---|---|---|---|---|---|
| Height of | 3.0 | 3.5 | 4.0 | 4.5 | 5.0 | 5.5 | 6.0 | 6.5 | 7.0 | 7.5 | 8.0 |
| Case | | | | | | | | | | | |
| (mm) | | | | | | | | | | | |
| Increase | 2.19 | 1.86 | 1.61 | 1.49 | 1.27 | 1.18 | 1.05 | 0.95 | 0.94 | 0.83 | 0.76 |
| in | | | | | | | | | | | |
| Capacity | | | | | | | | | | | |
| (%) | | | | | | | | | | | |

In addition, compared to a conventional can-shaped case having a thickness of 0.1 mm, when the thickness d1 of the body frame 130 is 0.1 mm and the thicknesses d2 and d3 of each of the first plate 140 and the second plate 150 is 0.05 mm, the increase in the internal capacity of the case 120 relative to the total height of the case 120 may be as shown in Table 2 below.

TABLE 2

| | | | | | | | | | | | |
|---|---|---|---|---|---|---|---|---|---|---|---|
| Height | 3.0 | 3.5 | 4.0 | 4.5 | 5.0 | 5.5 | 6.0 | 6.5 | 7.0 | 7.5 | 8.0 |
| of Case | | | | | | | | | | | |
| (mm) | | | | | | | | | | | |
| Increase | 4.48 | 3.75 | 3.29 | 3.07 | 2.55 | 2.59 | 1.82 | 1.66 | 1.59 | 1.59 | 1.58 |
| in | | | | | | | | | | | |
| Capacity | | | | | | | | | | | |
| (%) | | | | | | | | | | | |

As a result, by using the case of the secondary battery formed by assembling the plates designed to seal the body frame and the open surfaces of the body frame, it may be possible to manufacture amorphous secondary batteries having various shapes and materials. In addition, because the body frame and the first and second plates may be welded together, it may be possible to skip the pressing process, thereby reducing the cost of manufacturing the secondary battery.

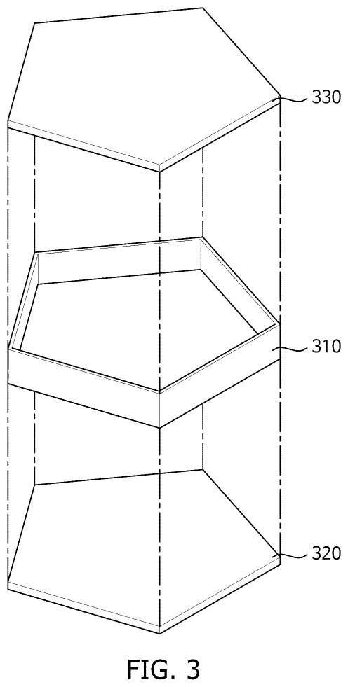

FIG. 3 shows an example of a case of a secondary battery according to one embodiment of the present disclosure. In this example the planar shape of the case of the secondary battery is a pentagonal shape, corresponding to the planar shape of an electrode assembly, and may include a body frame 310 with two open sides facing each other, a first plate 320 coupled to the edge of an open first surface, e.g., a lower surface, of the body frame 310, and a second plate 330 coupled to the edge of an open second surface, e.g., an upper surface, of the body frame 310 facing the first surface. Shapes other than a pentagonal shape are likewise within the scope of this disclosure. Here, the edge of the first surface of the body frame 310 and the outermost area of the first plate 320 may be welded together. Similarly, the edge of the second surface of the body frame 310 and the outermost area of the second plate 330 may be welded together.

In one embodiment, a thickness of the body frame 310 may be greater than a thickness of at least one of the first plate 320 and the second plate 330. In addition, the thickness of the first plate 320 may be different from the thickness of the second plate 330. Furthermore, the thickness of the body frame 310, the thickness of the first plate 320, and the thickness of the second plate 330 may be different from each other.

In one embodiment, at least one of the body frame 310, the first plate 320, and/or the second plate 330 may contain an alloy material. In an example, at least one of the body frame 310, the first plate 320, and/or the second plate 330 may contain stainless steel. However, the present disclosure is not limited thereto, and an aluminum alloy, a nickel alloy, etc. may also be contained within the body frame 310, the first plate 320, and/or the second plate 330. In addition, the material of the body frame 310 may be different from the material of the first plate 320, and the material of the first plate 320 may be different from the material of the second plate 330.

In one embodiment, the planar shape of at least one of the first plate 320 and the second plate 330 may correspond to the planar shape of the electrode assembly accommodated in the case. In addition, the planar shape of the body frame 310 may also correspond to the planar shape of the electrode assembly accommodated in the case. In an example, referring to FIG. 3, when the planar shape of the electrode assembly accommodated in the case is pentagonal, the planar shape of each of the first plate 320, the second plate 330, and the body frame 310 may be pentagonal.

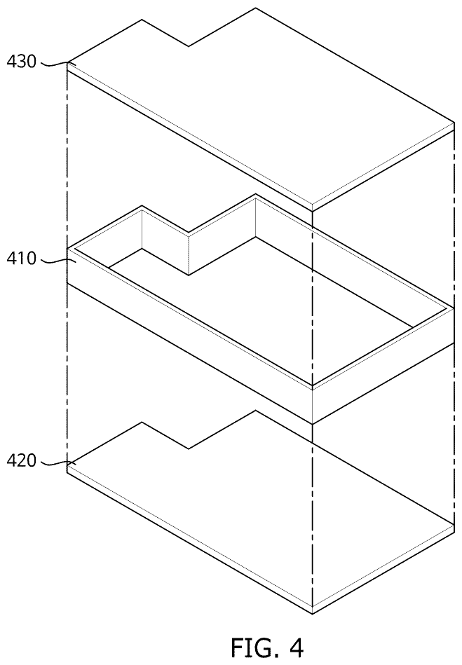

FIG. 4 shows an example of a case of a secondary battery according to one embodiment of the present disclosure. As illustrated, the planar shape of the case of the secondary battery in FIG. 4 is an amorphous hexagon, corresponding to the planar shape of an electrode assembly, and may include a body frame 410 with two open sides facing each other, a first plate 420 coupled to the edge of an open first surface, e.g., a lower surface, of the body frame 410, and a second plate 430 coupled to the edge of an open second surface, e.g., an upper surface, of the body frame 410 facing the first surface. Here, the edge of the first surface of the body frame 410 and the outermost area of the first plate 420 may be welded together. Similarly, the edge of the second surface of the body frame 410 and the outermost area of the second plate 430 may be welded together.

In one embodiment, the planar shape of at least one of the first plate 420 and the second plate 430 may correspond to the planar shape of the electrode assembly accommodated in the case. In addition, the planar shape of the body frame 410 may also correspond to the planar shape of the electrode assembly accommodated in the case. In an example, referring to FIG. 4, when the planar shape of the electrode assembly accommodated in the case is an amorphous shape, the planar shape of each of the first plate 420, the second plate 430, and the body frame 410 may correspond to the amorphous shape of the electrode assembly.

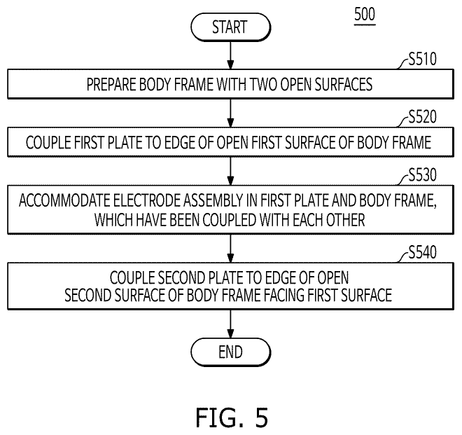

FIG. 5 is a flow chart of an example of a method 500 of manufacturing a secondary battery according to one embodiment of the present disclosure. As illustrated, the method 500 of manufacturing a secondary battery may begin by preparing a body frame with two open surfaces at S510. Here, the body frame may have a planar shape corresponding to the planar shape of the electrode assembly. Thus, pressing, punching, etc. may be performed on a flat plate of a metal material for the body frame to be manufactured with an accommodating space in a planar shape corresponding to the planar shape of the electrode assembly.

Thereafter, a first plate may be coupled to the edge of an open first surface of the body frame at S520. Specifically, the edge of the first surface and the outermost area of the first plate may be welded together.

Then, the electrode assembly may be accommodated in the first plate and the body frame, which have been coupled with each other, at S530. Here, the planar shape of the first plate may correspond to the planar shape of the body frame or the electrode assembly.

Next, a second plate may be coupled to the edge of an open second surface of the body frame facing the first surface at S540. Specifically, the edge of the second surface and the outermost area of the second plate may be welded together. Here, the planar shape of the second plate may correspond to the planar shape of the body frame or the electrode assembly.

In one embodiment, the electrode assembly may include a first electrode plate having a first polarity, a separator, and a second electrode plate having a second polarity different from the first polarity. In this case, an electrode terminal may be arranged on a third surface of the body frame. Here, the third surface may be different from the first surface and the second surface. In addition, the electrode terminal may be electrically connected to the first electrode plate or the second electrode plate.

In one embodiment, the thickness of the body frame may be greater than the thickness of at least one of the first plate and the second plate. In addition, the thickness of the first plate may be different from the thickness of the second plate.

In one embodiment, at least one of the first plate, the second plate, and the body frame may contain an alloy material. In addition, the material of the first plate may be different from the material of the body frame. In other embodiments, the material of the first plate may be different from the material of the second plate.

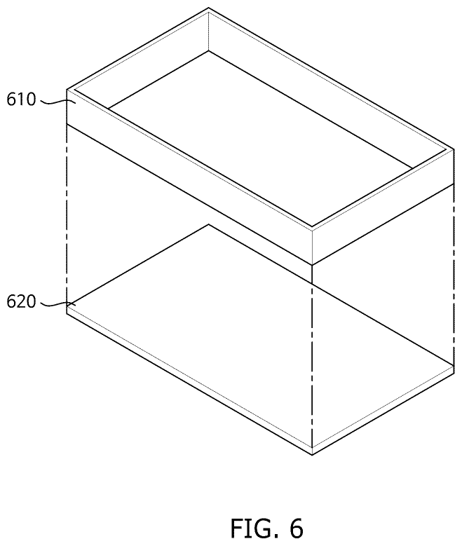

FIG. 6 shows an example of how a body frame 610 is coupled with a first plate 620 according to one embodiment of the present disclosure. In one embodiment, the first plate 620 may be coupled with the body frame 610 having two open surfaces facing each other. Specifically, the first plate 620 may be coupled to the edge of the open first surface, e.g., a lower surface, of the body frame 610. In this case, the edge of the first surface of the body frame 610 and the outermost area of the first plate 620 may be welded together.

In one embodiment, the material of the body frame 610 may be different from the material of the first plate 620. In addition, the thickness of the body frame 610 may be different from the thickness of the first plate 620. Specifically, the thickness of the body frame 610 may be greater than the thickness of the first plate 620.

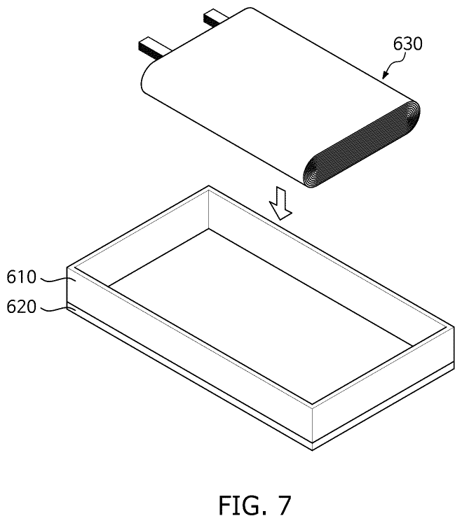

FIG. 7 shows an example of how an electrode assembly 630 is accommodated in a case according to one embodiment of the present disclosure. In one embodiment, the electrode assembly 630 may be accommodated in the body frame 610 and the first plate 620, which have been coupled to each other. Here, the electrode assembly 630 may include a first electrode plate having a first polarity, a separator, and a second electrode plate having a second polarity different from the first polarity.

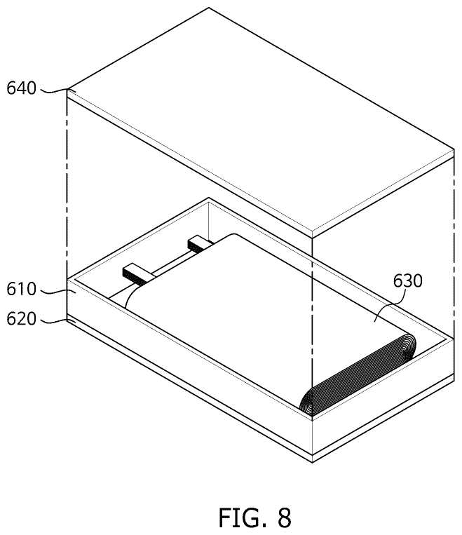

FIG. 8 shows an example of how the body frame 610 is coupled with a second plate 640 according to one embodiment of the present disclosure. In one embodiment, the second plate 640 may be coupled to the body frame 610 with the first plate 620. Specifically, the second plate 640 may be coupled to the edge of the open second surface, e.g., an upper surface, of the body frame 610 facing the first surface. In this case, the edge of the second surface of the body frame 610 and the outermost area of the second plate 640 may be welded together. Accordingly, the first plate 620, the body frame 610, and the second plate 640 may be coupled to each other to form the appearance of the secondary battery.

In one embodiment, an electrode terminal may be placed on a third surface of the body frame 610 before the body frame 610 is coupled to the second plate 640. The electrode terminal may be electrically connected to the first electrode plate or the second electrode plate of the electrode assembly 630. Here, the third surface may be different from the first surface and the second surface.

In one embodiment, the material of the second plate 640 may be different from the material of the body frame 610. In addition, the material of the second plate 640 may be different from the material of the first plate 620.

In one embodiment, the thickness of the body frame 610 may be different from the thickness of the second plate 640. Specifically, the thickness of the body frame 610 may be greater than the thickness of the second plate 640. In addition, the thickness of the second plate 640 may be different from the thickness of the first plate 620.

In one embodiment, the planar shape of the body frame 610 may correspond to the planar shape of the electrode assembly 630. In addition, the planar shape of the first plate 620 may also correspond to the planar shape of the electrode assembly 630. In addition, the planar shape of the second plate 640 may also correspond to the planar shape of the electrode assembly 630. In other embodiments, the planar shape of the second plate 640 may correspond to the planar shape of the first plate 620.

In FIGS. 6 to 8, the planar shape of the first plate 620, the body frame 610, and the second plate 640 is rectangular, but the present disclosure is not limited thereto. For example, as described above with reference to FIGS. 3 and 4, the planar shape of the first plate 620, the body frame 610, and the second plate 640 may be various amorphous shapes other than a rectangular shape.

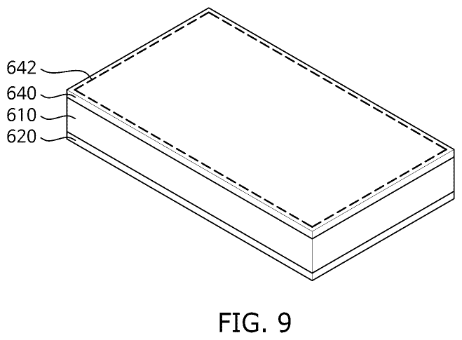

FIG. 9 shows an example of a welding area 642 according to one embodiment of the present disclosure. In one embodiment, the edge of the first surface of the body frame 610 and the outermost area of the first plate 620 may be welded together. Similarly, the edge of the second surface of the body frame 610 and the outermost area of the second plate 640 may be welded together. Referring to FIG. 9, the welding area 642 of the second plate 640 may be formed along the edge of the second surface of the body frame 610. For ease of welding, the thickness of the body frame 610 may be greater than the thickness of the second plate 640. Accordingly, the body frame 610 and the second plate 640 may be couped to each other without a separate flange for welding, so that the energy density of the secondary battery including the first plate 620, the body frame 610, and the second plate 640 may be improved.

FIG. 9 shows only the welding area 642 of the second plate 640 for convenience of description, but the welding area of the first plate 620 may be similar thereto.

Although the present disclosure has been described above with respect to embodiments thereof, the present disclosure is not limited thereto. Various modifications and variations can be made thereto by those skilled in the art within the spirit of the present disclosure.

What is claimed is:

1. A secondary battery comprising:
an electrode assembly comprising:
a first electrode plate having a first polarity;
a separator; and
a second electrode plate having a second polarity different from the first polarity; and
a case accommodating the electrode assembly,
wherein the case comprises:
a body frame with an open first surface facing an open second surface;
a first case plate coupled to an edge of the open first surface of the body frame; and
a second case plate coupled to an edge of the open second surface of the body frame facing the open first surface.

2. The secondary battery as claimed in claim 1, wherein a planar shape of the first case plate corresponds to a planar shape of the electrode assembly.

3. The secondary battery as claimed in claim 1, wherein a planar shape of the body frame corresponds to a planar shape of the electrode assembly.

4. The secondary battery as claimed in claim 1, wherein:
the edge of the open first surface and an outermost area of the first case plate are welded together; and
the edge of the open second surface and an outermost area of the second case plate are welded together.

5. The secondary battery as claimed in claim 1, wherein a thickness of the body frame is greater than a thickness of at least one of the first case plate and the second case plate.

6. The secondary battery as claimed in claim 1, wherein a thickness of the first case plate is different from a thickness of the second case plate.

7. The secondary battery as claimed in claim 1, wherein at least one of the first case plate, the second case plate, and the body frame contains an alloy material.

8. The secondary battery as claimed in claim 1, wherein a material of the first case plate is different from a material of the body frame.

9. The secondary battery as claimed in claim 1, wherein a material of the first case plate is different from a material of the second case plate.

10. The secondary battery as claimed in claim 1, further comprising an electrode terminal,
wherein the electrode terminal is electrically connected to the first electrode plate or the second electrode plate; and
wherein the electrode terminal is arranged on a third surface of the body frame, wherein the third surface is different from the open first surface and the open second surface.

11. A case of a secondary battery, comprising:
a body frame having a planar shape corresponding to a planar shape of an electrode assembly and having open an open first surface facing an open second surface;
a first case plate coupled to an edge of the open first surface of the body frame; and
a second case plate coupled to an edge of the open second surface of the body frame facing the open first surface.

12. The case of the secondary battery as claimed in claim 11, wherein:
the edge of the open first surface and an outermost area of the first case plate are welded together; and
the edge of the open second surface and an outermost area of the second case plate are welded together.

13. The case of the secondary battery as claimed in claim 11, wherein a thickness of the body frame is greater than a thickness of at least one of the first case plate and the second case plate.

14. The case of the secondary battery as claimed in claim 11, wherein at least one of the first case plate, the second case plate, and the body frame contains an alloy material.

15. A method of manufacturing a secondary battery, comprising:
preparing a body frame having a planar shape corresponding to a planar shape of an electrode assembly, the body frame having an open first surface and an open second surface;
coupling a first plate to an edge of the open first surface of the body frame;
accommodating the electrode assembly in the first plate and the body frame, which have been coupled with each other; and
coupling a second plate to an edge of the open second surface of the body frame facing the open first surface.

16. The method as claimed in claim 15, wherein the coupling of the first plate comprises welding the edge of the open first surface and an outermost area of the first plate together.

17. The method as claimed in claim 15, wherein the coupling of the second plate comprises welding the edge of the open second surface and an outermost area of the second plate together.

18. The method as claimed in claim 15, further comprising:
arranging an electrode terminal on a third surface of the body frame; and
electrically connecting the electrode terminal to a first electrode plate or a second electrode plate, wherein
the electrode assembly comprises:
the first electrode plate having a first polarity;
a separator; and
the second electrode plate having a second polarity different from the first polarity, and
the third surface is different from the open first surface and the open second surface.

19. The method as claimed in claim 15, wherein a planar shape of the first plate or the second plate corresponds to the planar shape of the electrode assembly.

20. The method as claimed in claim 15, wherein a thickness of the body frame is greater than a thickness of at least one of the first plate and the second plate.
